(19) United States
(12) Patent Application Publication
(10) Pub. No.: US 2009/0196300 A1
(43) Pub. Date: Aug. 6, 2009

(54) METHOD FOR FORWARDING DATA PACKETS AND COMMUNICATION NETWORK HAVING FLOODING TRANSPORT PROPERTIES

(75) Inventors: Georg Carle, Tübingen (DE); Jochen Schiller, Berlin (DE); Andreas Schrader, Lübeck (DE); Burkhard Stiller, Zurich (CH)

Correspondence Address: LERNER GREENBERG STEMER LLP, P O BOX 2480, HOLLYWOOD, FL, 33022-2480, US

(73) Assignees: UNIVERSITAT Zurich Prorektorat Forschung, Berlin (CH); ISNM International School of New Media at the University of Lubeck

(21) Appl. No.: 12/306,779

(22) PCT Filed: Jun. 14, 2007
(86) PCT No.: PCT/EP2007/005244

§ 371 Date: Dec. 29, 2008

(30) Foreign Application Priority Data
Jun. 27, 2006 (EP) EP 06013176.0

(51) Int. Cl. H04L 12/56; H04L 9/00

(52) U.S. Cl. 370/400; 713/150

(57) ABSTRACT

A method of forwarding data packets in a communication network includes the following steps: a) generating a stream of data packets at a first subscriber; b) adding to each of the data packets in the stream a recipient individualizing information to form individualized data packets; c) forwarding the individualized data packets to a first repeater node; d) flooding the individualized data packets from the first repeater node to any further subscriber connected to the first repeater node; e) flooding the individualized data packets to any further repeater node connected to the first repeater node; f) flooding the individualized data packets in any further repeater node analogous to the steps d) and e); g) connecting any possible further subscriber of the stream of individualized data packets to a repeater node selected from a group containing the first repeater node and any further repeater nodes and g) enabling only those of the any possible subscribers to access a content of the individualized data packets when able to identify as authorized subscriber by knowledge of the recipient individualizing information added to the data packets.

The present invention relates to a method for forwarding data packets in a communication network. Further, the present invention relates to a communication network having flooding transport properties.

Networking and the network in its core form determine the crucial backbone of today's information technology. Since data has to be transmitted, since distributed systems offer data on multiple locations world-wide, and since the cooperation and collaboration across physical domains in daily business, research, and pleasure even expands from year to year by two-digit ranges, the network needs to handle a variety of highly diverse requirements. Thus, as for example the Internet today shows, a certain level of technology complexity—even for a packet-based network compared to a connection-oriented approach—has been reached. This level requires in its operation and maintenance a number of highly sophisticated control algorithms and mechanisms, such as routing, flow control, or congestion control. Additionally, this level of complexity requires also many advanced and cost-intense hardware devices, such as backbone routers, access points, and network monitoring boxes.

For illustrating the complexity the following metaphor is considered. So far and until today, the Internet works as if water is put in buckets (packets) and handed forward piece by piece (packet routing); while the former will be done by users and applications, following well-defined protocols and message formats, the latter requires inter- and intra-domain routing schemes, routing tables to be set-up, maintained and corrected.

Exactly at this stage, it is the objective of the present invention to apply a principle and very basic optimization approach which minimizes this technology complexity described and maximizes the utility of the network customers at the same time.

These objective are achieved according to the present invention by a method for forwarding data packets in a communication network,

comprising the steps of:

a) generating a stream of data packets at a first subscriber;
b) adding to each of the data packets in said stream a recipient individualizing information to form individualized data packets;
c) forwarding the individualized data packets to a first repeater node;
d) flooding the individualized data packets from the first repeater node to any further subscriber connected to said first repeater node;
e) flooding the individualized data packets to any further repeater node connected to said first repeater node;
f) flooding the individualized data packets in any further repeater node analogous to the steps d) and e);
g) connecting any possible further subscriber of said stream of individualized data packets to a repeater node selected from a group containing the first repeater node and any further repeater nodes and
g) enabling only those of said any possible subscribers to access a content of said individualized data packets when able to identify as authorized subscriber by knowledge of the recipient individualizing information added to the data packets.

This method allows that all of those mechanisms and devices mentioned above can be neglected as a whole. The inventive method covers on the first hand robustness, security, multicasting-capability, and Quality-of-Service (QoS). Secondly, ease-of-use, technological efficiency, and economic efficiency are fulfilled as well. The inventive method is—speaking in the metaphor given—simply to let the water flow and find its way. If a subscriber or an application needs water (data packets), the user or application just takes it, wherever he is. Since all data packets (finally driven by applications) comprising the recipient individualizing information on application-level (this obeying to former end-to-end networks) are flooded into the network, these individualized data packets are available—in principle—at any locations, where access to this network will be granted.

Furthermore, no message format in the traditional networking sense is required any more. Even more, no standard addressing on the network level is required any more, besides, of course, the unique and secure authentication of a subscriber/application is based on the recipient individualizing information that can be considered as a private/public key pair between the subscriber generating the data packets and the recipient intended to receive these data packets. Network transport mechanisms to distribute the data packet to all possible access points are rather simple and, preferably, filtering the data packet within some areas of the network may be required, where no further subscriber will be located.

However, once achieved, the ubiquitous society can be approached closely, since the access to information, typically supported by a very small access point, becomes the only crucial step. Thus, the world-wide information gap, mainly dominated by quite expensive networking infrastructures will diminish, hopefully, fade-away in the future. Driven by the easy-to-use network access scheme, mainly supported by the repeater nodes and the final access points, any user has the possibility to tune into the network.

With respect to the network, the above mentioned objectives are achieved according to the invention by a communication network for forwarding data packets from a first subscriber to an intended subscriber; comprising:

a) the terminal with said first subscriber generating a stream of data packets;
b) means for adding to each of the data packets in said stream a recipient individualizing information to form individualized data packets;
c) means for forwarding the individualized data packets to a first repeater node;
d) said first repeater node flooding the individualized data packets from the first repeater node to any further subscriber connected herewith;
e) said first repeater node flooding the individualized data packets to any further repeater node connected herewith;
f) any further repeater node flooding the individualized data packets analogous to the steps d) and e);
g) means for connecting any possible further subscriber of said stream of individualized data packets to a repeater node selected from a group containing the first repeater node and any further repeater nodes and
g) means for enabling only those of said any possible subscribers to access a content of said individualized data packets when able to identify as authorized subscriber by knowledge of the recipient individualizing information added to the data packets.

Due to the underlying concept of accessibility to the data packets at any location within the network, it is crucial that the key pair between the first subscriber who generates the flow of data packets and the intended addressees can be shared in a simple manner. Therefore, in a preferred embodiment of the present invention the step b) may further comprise to encrypt the individualized data packets by an encryption algorithm which is indicated in said recipient individualizing information. In case the addressee (recipient) knows the key to decrypt the individualized data packets, the content of the data packets is accessible to the recipient(s). This key is comprised in the recipient individualizing information. Alternatively, this could be implemented by using an encrypted “address” (encrypted receiver identifier) that can exclusively be decrypted by the intended recipient provided he is aware of the individualized decryption key.

Another preferred embodiment for providing a secure transfer of the data packets between first subscriber and the intended recipient(s) may contain that said recipient individualizing information comprises a download clearing code and the content of the individualized data packets is accessible exclusively to those of said any possible subscribers that share the knowledge of the download clearing code with the first subscriber.

Despite the assumption of a nearly “unlimited” transport capacity of the network, it is of course very helpful to limit the traffic to an extent that regions where the addressee is obviously not present are not flooded with the individualized data packets. Therefore, the recipient individualizing information may comprise a deliver information and any of said repeater nodes comprise a policy framework using said deliver information to selectively decide to which of said repeater nodes the individualized data packets have to be forwarded. This deliver information may—in a preferred example—comprises a geographical information of the location of the intended subscriber. This geographical information can be coded by a 2-digit information, like US, CA, DE, FR, GB, IT etc., that is comprised in the recipient individualizing information. Additionally, the policy framework implemented with any of the repeater nodes comprises an information about the connectivity of each repeater node and can therefore filter individualized data packets. In other words, individualized data packets are exclusively flooded to those repeater nodes which are further useful in terms of transporting the individualized data packets into the desired region indicated by the geographical information comprised in the recipient individualizing information.

Further, there can be applied some additional considerations on how to use the bandwidth available within the network in a way that quality of service attributes can be added to the network that might be short in capacity during typical heavy load periods during a day. In further preferred embodiment of the present invention, the recipient individualizing information may comprise a hierarchical information and any of said repeater nodes comprise a policy framework using said hierarchical information to selectively decide to which of said repeater nodes the individualized data packets have to be forwarded. This hierarchical information can be just a one-digit code, like A, B, C, D or E etc., that indicates the priority for flooding the respective individualized data packets. Considering the policy framework associated with each repeater node, there can be provided a flooding list for each class of hierarchical information resulting in a subsequent flooding of the individualized data packets. As an example, data packets having class B are not flooded unless the list for data packets having class A is empty. This can be compared to a communication structure when using SIP where different INVITE lists may exist.

Further preferred embodiments of the present invention are indicated within the scope of any additional patent claim.

Preferred examples of the present invention are described hereinafter by referring to the accompanied drawings. Thereby, the drawing illustrates in:

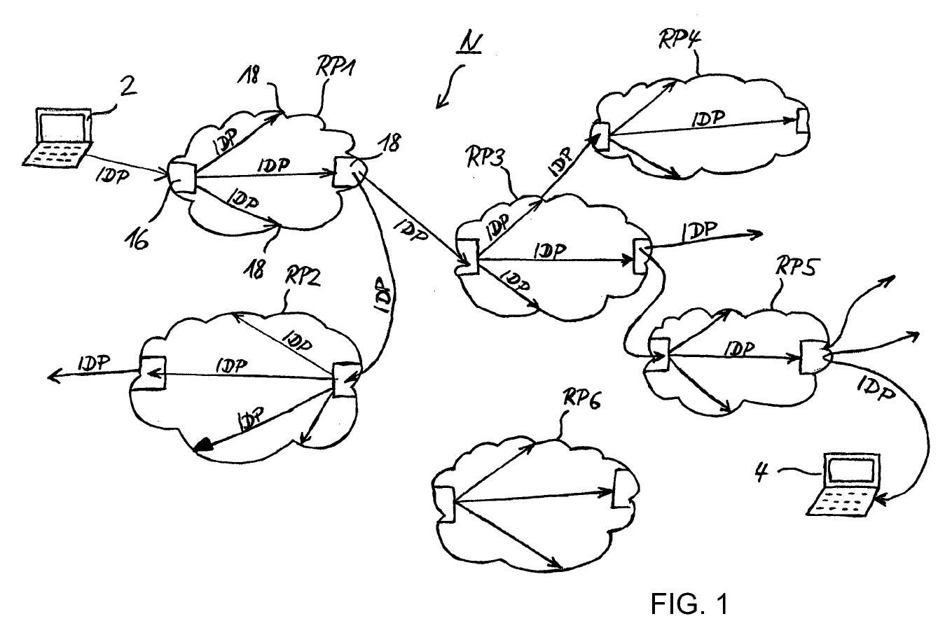

FIG. 1 a schematic overview over a communication network applying the flooding approach; and

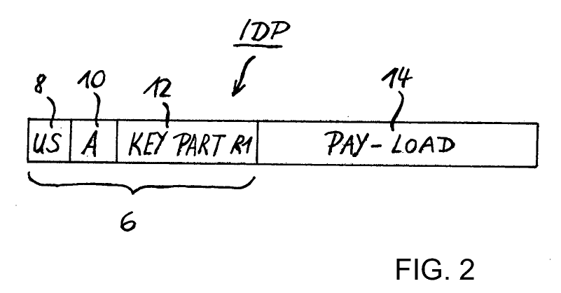

FIG. 2 a schematic structure of an individualized data packet forwarded in a communication network according to FIG. 1.

FIG. 1 illustrates schematically a communication network N comprising a number of repeater nodes RP1 to RP6 and a first subscriber 2 connected to the repeater node RP1 and a second subscriber 4 connected to the repeater node RP5. Due to the technical improvements related to bandwidth and CPU speed the network N is considered to have virtually endless bandwidth as well as virtually endless CPU speed as well as virtually endless memory capacity. As shown in FIG. 2, in the network N a very simple approach for the protocol architecture is applied. As compared to former protocol structures, in the new network N for an individualized data packet IDP only the layer 1 for the physical media (payload 14), layer 2a for the Media Access Control (MAC) and layer 7 as application-layer are required anymore. Layer 2b to 6 become completely obsolete.

To convert now the “normal” data packet into the individualized data packet IDP, a recipient individualizing information 6 is added to the payload 14. Beside a geographical information 8 (here: intended recipient is located in the U.S.) and a prioritizing information 10 (here: highest priority A is chosen) the recipient individualizing information 6 comprises a key part 12 containing the relevant information which allow the intended recipient exclusively to access the pay load information 14. Therefore, the first subscriber 2 and the second subscriber 4 being the intended recipient of the individualized data packets IDP have to share this key part 12 since the individualized data packets IPD unless that they are flooded to any subscriber connected to the network N are only usable for those subscribers sharing the recipient individualizing information 6 with the subscriber generating the individualized data packets IDP. Therefore, the key part 12 can be considered as a part containing a signature which has to be known by the intended recipient (second subscriber 4).

FIG. 1 further illustrates a sender based flooding of the individualized data packets IDP in the network N. The first subscriber 2 sends a flow with the individualized data packets IDP to an ingress port 16 of the first repeater node RP1 (the one to which he is connected). The first repeater node RP1 duplicates the IDP as often as needed to be able to send the individualized data packets IDP to all its network egress points 18. From these egress points 18, the communication of the individualized data packets IDP is now a tree like flooding. At the boundaries of each repeater node RP1 to RP6, the forwarding of the individualized data packets IDP based for example on a filtering by the geographical information 8 may be optimized in terms of an intelligent flooding. As shown in the example according to FIG. 1, the repeater node 4 has an internal policy framework that does not support further broadcast of individualized data packets IDP having the geographical information 8 equal to US. The repeater node RP6 in this example is not addressed from any other repeater node RP1 to RP5 since all the other repeater nodes RP1 to RP5 comprise the policy framework to broadcast the idp IDP not to repeater node RP6 when the geographical information 8 is equal to US.

Of course, this network N allows for a tremendous number of variations and modifications within the scope of the present invention. For example, the data to be transmitted is not specifically placed into a stream of data packets, but rather distributed into the whole sea of data packets, which would imply that the recipient can compile the original message from any collection of incoming bits. This compilation of the original message may be based on typical forward error correction codes or any other redundancy-based coding technology.

Further, a wave propagation model can be used for damping packets, generalized by probability. The network could, e.g., apply filtering of packets depending on the logical distance from the source, thus flattening waves of packets.

With respect to the use of private/public/group key in the key part 12, also the complete data packet can be encrypted. Again, the intended recipient has to share the knowledge of the encryption algorithm (or at least the knowledge which algorithm was used) with the original sender in order to be able to access the data. At the edge of the network N, proxies can be used to filter out the idp IDP relevant for the intended recipient.

Therefore, the present invention addresses the core challenges of distributed systems and specifically focuses on fully decentralized, easy-to-use and efficient operation. The robustness of the system is impressive since a failure of an intermediate repeater node will not jeopardize the functioning of the network N. The number of actions to achieve a network not susceptible to single point of failure can be dramatically reduced as compared to the redundancy approach in the art networks. Also from the security perspective, the present invention is less susceptible to corruption, since for each user exists an individual public/private key pair. Therefore, authenticity is guaranteed since the application of a private key reveals only those individualized data packets IDP where the user or the application is the intended recipient.

Even in the light of the social contemporary problems with respect to a radicalization of a limited number the present invention offer enormous freedom with regard to anonymity since physical addresses, like MAC addresses, IP addresses, are not needed any longer. A further collateral effect achieved by the flooding concept is that an intended recipient finds the data packets (messages) send to him everywhere due to the accessibility of individualized data packets IDP to those subscribers knowing the recipient individualizing information.

Furthermore, all efforts in today's network (traffic) management are obsolete, too, since all individualized data packets IDP travel everywhere (except in case of filtering and/or prioritizing).

The present invention has also been implemented on a simulation on the scale of the network N. The results hereinafter discussed have been taken from a simulation period of 60 seconds. The results further explain the additional load on the network, when using the general flooding concept as compared to traditional routing. The general flooding in principle has the decisive advantage that all routers within its network form a random collection of transit domains and stub domains and, therefore, show significantly less complexity than traditional routers.

For traditional routers, the results are as follows: Lookups are equal to 38,634 of which 37,901 have been positive what corresponds to a probable success rate of 98%. 301,404 data packets have been sent having a volume sent of 4.52106e+07 Bytes. The average path length laid in the range of 7.8 hops.

For the repeater nodes working with the general flooding concept, the same number of 38,634 lookups yields a probable success rate of 99% with about 38,352 positive lookups. 58,988,526 packets have been sent with a volume sent of about 8.84828e+09 Bytes.

For a typical topology as applied for the simulation the results achieved lead to the following decisive statements showing the significant advantages of the general flooding concept over the prior art. In a worst case scenario (without use of filter or other hierarchical information) the general flooding concept broadcasts approx. 100 times more data packets in comparison to conventional routing. This result is within an expected volume range as the use of simple filters (such as geographical filters) leads already to a significant reduction of the network load. In addition, based on long-term experiences, it can be expected that the capacity of the network N doubles every nine months. Thus, the following statements taken in the following subsection can be deducted.

With respect to the volume sent, the general flooding concept causes traffic 100 times bigger than with conventional routing. This factor does not present a severe risk to the traffic volume since this difference is attenuated by the current increase of steady backbone capacities.

With respect to the performance, the general flooding concept does not involve a limitation of the performance capacity as the flooding itself does not require any extra effort. The most to be done in order to avoid the circulation of data packets (avoidance of cycles) is to use a TTL approach (Time to Live). An easily controllable TTL field might only be tested at the edges of an autonomous subsystem within the network N (like the subsystems with the repeater nodes RP1 to RP6) which means that all subsystems can only be simple optical hubs. These distribute an incoming individualized data packets IDP to all egress points, thereby ensuring that a check only takes place at the edge of the autonomous subsystem. At present, there are about 15.000 autonomous subsystems worldwide of which only a few are pure backbone networks. Most of these autonomous subsystems are only stub domains. If, therefore, the TTLs are to be counted in the autonomous subsystem then it is sufficient to make a short check at the edge of an autonomous subsystem, e.g., by using a 16-bit number. Ideally, each autonomous subsystem may be regarded as a mega hub. The filtering intelligence is, therefore, only required at the edge of an autonomous subsystem which leads to simplification and ultimately to an increase of performance capacity.

An alternative would be the use of the sequence numeration using the “aging” concept; however, this involves a higher effort.

With respect to cost advantage, stability and reliability of the simple routing (general flooding concept) in comparison to the conventional routing are evident. A router port costs approximately ten times as much as a switch port which again costs about ten times as much as a repeater port. These ports are essential to the flooding solution and their use explains the mentioned cost advantage. The system is stable and robust since practically all packets can be routed anywhere. In this simple scenario there are no wrong configurations of routing tables. In case of a system breakdown this is of no dramatic consequence as long as there are other possible routes.

The cost for the flooding concept compares favorably to the cost of traditional routing, i.e. when considering the cost of a router depending on the number of ports, the cost per port as well as the cost per router in relation to the number of routed packets, a typical port today costing between kε 25 and kε 120 for 1-10 Gbit/s links.

The part of the filter and the influence of the delay have to be looked at. In the worst case filtering has to be carried out at the speed of the physical connecting line (line speed). With line speed only the TTL has to be checked and a simple filter may possibly be used. In case of encryption, there will be significantly longer delays, however, this is independent of the fact of traditional routing versus flooding. High-end routers take a decision time of approximately 10 ns to forward a packet. A flooding hub would entail no noticeable delays, similarly neither would a simple filter. By using filters the impact of the network capacity (maximum volume to be transported) on the flooding can clearly be reduced. Finally, it has to be defined how to tailor the filters to ensure the best possible choice for the end users by using “keys” for freely accessible data streams. These keys may be filed as, e.g., in a TV program and the end user may simply “tune in”.

Individual keys—such as, e.g., a request/response scenario in the WWW (World Wide Web)—will be produced by the initiator, e.g., the web client. The server continues to be known by URL with the exception that the request is sent to (almost) all recipients at the same time. Compared with the traditional method, however, only the correct/right server will answer. This method does not need to guarantee any security as this will be procured for on higher levels. The correct/right server responds with data which again are sent to (almost) all. The recipient may then filter the response based on his own knowledge/code. This procedure is at the same time the most extreme and the most simple since the request is sent to all in the broadcast modus (the response is sent again to all in the broadcast modus, the rightful recipient chooses the matching response). To enhance security, encryption can be added. Today, the web traffic is not secure, therefore random packets can be duplicated in a data stream.

This procedure means that generic filters at the edge of autonomous subsystems (AS) would be the only ones. Companies could filter the traffic of TV stations, e.g., in a form to be defined of “AS x filters traffic of AS y due to missing peering contracts”. The general assumption that a network should be free of loops still holds true today and is guaranteed by BGP and a clever net design.

Applications (or helping agents) are responsible to filter their information out of this cache or data storage. This requires an implicit addressing only between trusted entities, which could be implemented by encrypted addresses—or receiver identifiers—in the data packets. As only the real recipient can decrypt any sender's message, a secure transfer has been achieved. In this case, any type of attacking is not possible any more. To reduce the amount of data forwarded, filters may be installed in different locations of the network to prevent some traffic from passing. This approach can be viewed as replacing routers with firewalls. In turn, this is a prevailing measure against Distributed Denial-of-Service (DDoS) attacks against the network itself, as the network survives any of those, being “omnipotent” by nature.

1-12. (canceled)

13. A method for forwarding data packets in a communication network which comprises the following steps:
a) generating a stream of data packets at a first subscriber;
b) adding to each of the data packets in the stream of data packets a recipient individualizing information to form individualized data packets;
c) forwarding the individualized data packets to a first repeater node;
d) flooding the individualized data packets from the first repeater node to any further subscriber connected to the first repeater node;
e) flooding the individualized data packets to any further repeater node connected to the first repeater node;
f) flooding the individualized data packets from the further repeater nodes to further subscribers and to any further repeater nodes in analogy to steps d) and e);
g) connecting any possible further subscriber of the stream of individualized data packets to a repeater node selected from a group containing the first repeater node and any further repeater nodes; and
h) enabling only those of the possible further subscribers to access a content of the individualized data packets upon identification as an authorized subscriber by knowledge of the recipient individualizing information added to the data packets.

14. The method according to claim 13, wherein step b) further comprises encrypting the individualized data packets with an encryption algorithm indicated in the recipient individualizing information.

15. The method according to claim 13, wherein said recipient individualizing information comprises a download clearing code and the content of the individualized data packets is accessible exclusively to those of the possible subscribers that share a knowledge of the download clearing code with the first subscriber.

16. The method according to claim 13, wherein the recipient individualizing information comprises a delivery information and any of the repeater nodes comprise a policy framework using the delivery information to selectively decide to which of said repeater nodes the individualized data packets are to be forwarded.

17. The method according to claim 16, wherein the delivery information comprises geographical information regarding a location of the intended subscriber.

18. The method according to claim 13, wherein the recipient individualizing information comprises a hierarchical information and any of the repeater nodes comprise a policy framework using the hierarchical information to selectively decide to which of the repeater nodes the individualized data packets are to be forwarded.

19. A communication network for forwarding data packets from a first subscriber to an intended subscriber, wherein a terminal with the first subscriber generates a stream of data packets, the network comprising:
a) means for adding to each of the data packets in the stream of data packets a recipient individualizing information to form individualized data packets;
b) means for forwarding the individualized data packets to a first repeater node;
c) wherein said first repeater node is configured to flood the individualized data packets from the first repeater node to any further subscriber connected therewith, and said first repeater node is configured to flood the individualized data packets to any further repeater node connected therewith;
d) wherein each further repeater node is configured to flood the individualized data packets to subscribers and further repeater nodes in analogy to said first repeater node;
e) means for connecting any possible further subscriber of said stream of individualized data packets to a repeater node selected from a group containing the first repeater node and any further repeater nodes; and
g) means for enabling only those of said possible subscribers to access a content of the individualized data packets when they are able to identify as authorized subscriber by knowledge of the recipient individualizing information added to the data packets.

20. The network according to claim 19, wherein said means for adding further comprise means for encrypting the individualized data packets by an encryption algorithm indicated in the recipient individualizing information.

21. The network according to claim 19, wherein the recipient individualizing information comprises a download clearing code and the content of the individualized data packets is accessible exclusively to those possible subscribers that share the knowledge of the download clearing code with the first subscriber.

22. The network according to claim 19, wherein the recipient individualizing information comprises a delivery information and any of said repeater nodes comprise a policy framework using the delivery information to selectively decide to which of said repeater nodes the individualized data packets should be forwarded.

23. The network according to claim 22, wherein the delivery information comprises a geographical information relating to a location of the intended subscriber.

24. The network according to claim 19, wherein the recipient individualizing information comprises a hierarchical information and any of said repeater nodes comprise a policy framework using said hierarchical information to selectively decide to which of said repeater nodes the individualized data packets are to be forwarded.
